(19) United States
(12) Patent Application Publication
(10) Pub. No.: US 2009/0094078 A1
(43) Pub. Date: Apr. 9, 2009

(54) ENVIRONMENTAL OFFSETS FOR SERVICES

(76) Inventor: Jonathan David Kaehne, Blackburn (AU)

Correspondence Address: Vedder Price PC, 222 NORTH LASALLE STREET, CHICAGO, IL, 60601, US

(21) Appl. No.: 12/245,261

(22) Filed: Oct. 3, 2008

(30) Foreign Application Priority Data
Oct. 5, 2007 (AU) 2007905464

(51) Int. Cl. G06Q 99/00

(52) U.S. Cl. 705/7; 705/500

(57) ABSTRACT

Techniques for providing services in a manner that takes into account the environmental impact of such service delivery are provided. In one embodiment, in response to a request for services from a prospective customer, the environmental impact of the requested service is determined based on analysis of each sub-service constituting the service. The resulting estimate of the environmental impact as well as any alternative delivery options having an effect on the estimated environmental impact may be presented to the prospective customer. In another embodiment, the potential customer may be provided the option to pursue an offset against the estimated environmental impact. In this manner, potential customers may be provided with more environmentally-conscious options when selecting a potential service provider.

### FIELD OF THE INVENTION

The invention relates generally to a means and method of determining and advising consumers, whether they be individuals or businesses, of the environmental impact of services that they consume. The invention is particularly useful for postal, freight and/or transport services and allows consumers to purchase a suitable or appropriate good or service to understand and potentially offset the environmental impact resulting from their choice of service to consume.

### BACKGROUND OF THE INVENTION

Consumers are becoming increasingly aware of the environmental impact of their activities and the negative impact upon the environment including global warming. Whereas in the past there was a general view that industry was predominantly responsible for environmental degradation, there has been a recent shift in focus from the activities of industry to the activities of individuals with respect to responsibility for environmental degradation.

In this regard, the prevailing view now-a-days focuses attention upon the demand for goods and/or services as organizations only seek to provide goods or services in response to demand. As demand primarily arises from individuals, attention is now clearly directed to the activities of individuals with respect to the impact upon the environment. As a result, individual consumers are now seeking to assess the impact of their activities upon the environment and to modify those activities to reduce the impact upon the environment.

One method of measuring impact upon the environment with respect to human activities is to measure the carbon emissions associated with individual human activities. In this regard, there are some very basic computer programs in existence that attempt to provide an estimate of the carbon emissions generated as a result of human activities such as travel by air, rail or automobile. The algorithms used in these programs are very basic and lack sophistication. As there is a need to provide consumers with a greater ability to understand the environmental impact of their consumption choices, there is a need to provide greater sophistication with respect to the information available and the detail contained within that information pertaining to the environmental impact of consumption choices.

Similarly, organizations are in need of a better understanding of the environmental impact of the services they offer to consumers as a competitive advantage may be gained in offering a service with a substantially lesser environmental impact as compared with the service offerings of competitors.

A discussion of documents, acts, materials, devices, articles or the like, which has been included in this section of the present specification is solely for the purpose of providing a context for the present invention. It is not to be taken as an admission that any or all of these matters form part of the prior art base or were common general knowledge in the field of the invention as it existed before the priority date of any of the claims herein.

### SUMMARY OF THE INVENTION

In one aspect, the present invention provides a method of informing prospective consumers of the environmental impact of the services offered by an organization, the method including:

receiving information from a prospective consumer with respect to the service required;

determining the environmental impact of each element in the delivery of all sub-services that enable delivery of the type of service required; and

presenting information to the prospective consumer including an estimate of the environmental impact of the delivery of the service required and, where available, alternative service delivery options and the respective environmental impact of those alternatives/options.

Once a consumer has had an opportunity to assess the environmental impact of the various service offerings, and potentially selected an alternative service delivery option in view of the information provided regarding the alternatives, they may also seek to purchase a good or service to offset the environmental impact of their service choice. The offset choice may include a donation or paying a premium as compared with the advertised price for the service in order to offset or equalize the environmental impact.

For example, a consumer may be presented with a range of choices such as a donation to an investment fund that invests in renewable energy sources or some other form of activity that has a positive, or balancing, impact upon the environment. Importantly, as a result of providing consumers with detailed and accurate information pertaining to the environmental impact of their service choice, the consumer may either elect to alter their original service choice and select a service that has a reduced impact upon the environment and/or pay an appropriate sum to precisely offset the environmental impact of their service choice.

In particular, the present invention enables an organization to more effectively engage a consumer with respect to their desire to address the impact of their activities upon the environment and provides consumers with sufficiently detailed information to enable them to select from a range of service offerings depending upon the environmental impact associated with the provision of those services.

The present invention is particularly well suited to postal organizations where a consumer may require delivery of an item within a period of time. However, consumers are generally not aware of the environmental impact of their choices and may also not be aware of alternative service offerings that can accommodate the delivery of the item with a lower environmental impact.

In this regard, there may exist a range of service levels for a particular service that delivers an item of post from a source to a destination location. Whereas a consumer may be convinced that an express service level with a relatively high environmental impact is required to deliver the item of post within the desired time period, there may exist a lesser service level for the same service that accommodates the consumers' requirements.

Similarly, organizations providing services can gain greater knowledge of the environmental impact of their service offerings which in turn enables them to consider and/or implement changes to the service delivery mechanisms employed in an attempt to reduce the environmental impact of their service offerings. In particular, analysing the environmental impact of sub-services may identify a particular sub-service with a high environmental impact that is common to the delivery of a large range of services. In this event, the greater knowledge obtained by the organization will enable them to identify those sub-services that provide the greatest contribution to environmental impact and hence provides a focus for which sub-services the organization should seek to modify and/or develop in an attempt to reduce the overall environmental impact of their service offerings.

In an exemplary embodiment, the environmental impact that is determined for each element in the delivery of all sub-services is the carbon emissions that result from the delivery of those sub-services. Of course, other environmental impact measures such as sulfur dioxide emissions, particulates or uncombusted hydrocarbons could be used as could a combination of any two or more measures.

Whilst the present invention is particularly well suited to postal organizations, it is also suited to the freight and transport industries that would also benefit from providing consumers with information relating to the environmental impact of their service offerings and the availability of alternative service offerings and/or service levels and the environmental impact of those alternatives.

In another exemplary embodiment, the determination of the environmental impact may include the level of service for a particular service offering, the source and destination location and the transport path therebetween for the collection and delivery of an item, the transport mode (such as rail, road, air or sea), the weight and size of the item and the technology to be implemented in delivering the item. With respect to technology implementation, a particular example is hybrid mail wherein an item of mail may be transmitted electronically from the source to a location that is relatively close to the destination at which point the item of mail is printed and transported in physical form for the final part of the journey to the destination location.

With respect to the transport path between the source and destination locations, a usual route for implementing a service to transport an item may pass through a region that is already heavily impacted from an environmental perspective. In this instance, a consumer may be prepared to consider an alternate route for the transport of their item to avoid compounding the environmental impact in that region and may even be prepared to accept a longer delivery time in order to accommodate the alternate route. In any event, having a better understanding of the environmental impact of their choices, a consumer may either alter those choices in order to reduce the environmental impact of same or alternatively, or additionally, may be prepared to pay a premium price for a particular service option with the premium component being directed to an environmental offset fund. In addition to considering alternate routes, the transport of an item between source and destination locations may be capable of being effected by a range of service delivery mechanisms with differing levels of environmental impact. In this instance, a consumer may elect a service delivery mechanism that has a lower environmental impact and again may also consider paying a premium in order to select the service delivery mechanism with the lower environmental impact.

The techniques described herein may be embodied by stored, executable instructions that are executed by one or more suitable processing devices such as personal or server computers.

In an exemplary embodiment, the interface with the prospective consumer is a web-enabled interface that is implemented on a device connected to a data communications network such as the internet.

The determination of the environmental impact of sub-service elements may include monitoring and regularly collecting and reporting information regarding the sub-service elements. In another embodiment, the collected information acts as an input to algorithms that are developed to accurately calculate the environmental impact of sub-service elements.

In another aspect, the present invention provides an environmental impact calculator that calculates the environmental impact of the delivery of services by an organization, the calculator receiving information from a prospective consumer with respect to a required service, establishing the available services offered by the organization that accommodate the consumers' requirements, calculating the environmental impact of the relevant services by summing the environmental impact of the delivery of each sub-service that contributes to the delivery of the relevant service and providing the calculated environmental impact for each service.

In one exemplary embodiment, the calculation takes into consideration the following variables:
service level;
sub-services;
source and destination locations;
transport mode;
transport route between locations;
environmental impact factors (e.g. gaseous emissions, particulate emissions, noise, consumables, etc);
volume and dimensions;
weight;
special handling requirements (e.g. dangerous goods); and/or
technology options.

### BRIEF DESCRIPTION OF THE DRAWINGS

The present invention will now be described with reference to the accompanying drawings, which illustrate exemplary embodiments of the present invention, wherein:

FIG. 1 is a flow chart of the method steps employed by an organization seeking to collect the necessary information required to provide consumers with an accurate estimation of the environmental impact associated with the services offered by the organization; and

FIG. 2 is a flow chart of the method steps associated with a consumer seeking to fulfill a service requirement.

### DETAILED DESCRIPTION OF EXEMPLARY EMBODIMENTS

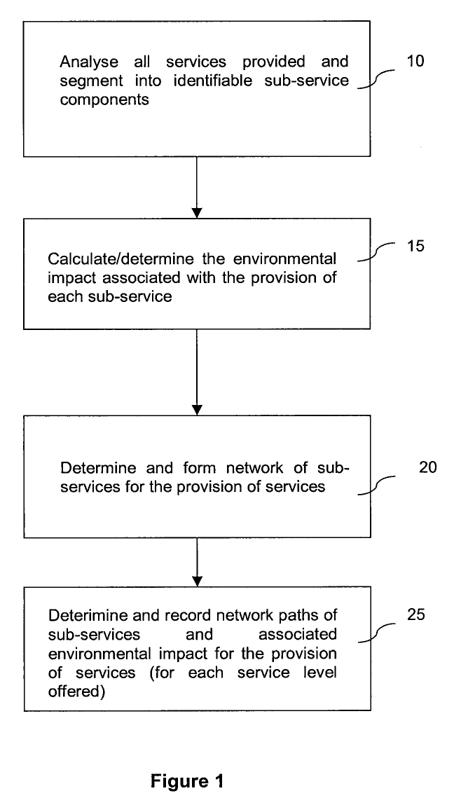

With reference to FIG. 1, a flow chart is provided detailing the primary steps involved when an organization seeks to collect the necessary information to calculate the environmental impact of their various service offerings.

At step 10, the organization analyses all of their service offerings and segments those service offerings into identifiable sub-service components that collectively enable the delivery of services to consumers. The environmental impact associated with the provision of each sub-service is determined (step 15).

In the instance of a postal system, the service of collecting mail from a source location and delivering to a destination location may be segmented into the following identifiable sub-service components:
(i) vehicle collects postal item from post box and delivers to a sorting station;
(ii) electrically powered sorting equipment routes the postal item to the correct delivery transfer point;
(iii) vehicle transports postal item to a subsequent transfer point;
(iv) manual collection and hand delivery of the postal item to the destination location.

In the sequence of sub-services (i) to (iv) identified above, the activities involving the use of a vehicle incur a primary environmental impact as a result of the combustion of hydrocarbon fuel. Whereas, other sub-services that involve the use of equipment that consume electrical energy, the primary environmental impact arises from the amount of electrical energy consumed. For vehicle based activities, empirical testing may be the preferred method for assessing the environmental impact whereas, in the case of sorting equipment consuming electrical energy, a more precise calculation may be preferred based upon the average usage of electrical energy used by the sorting equipment to sort the types of postal items that are offered to consumers for processing through the postal system.

In any event, at the completion of step 15, all services offered by an organization are segmented into identifiable sub-service components for which an environmental impact is determined.

At step 20, the organization determines the network of sub-services from which all service offerings are provided to consumers (step 20). In this respect, it is likely that organizations would already understand the network of sub-services that may be combined to provide services to consumers. Accordingly, this step may have previously been performed and hence this step may be optional.

In any event, at step 25, the organization then determines and records network paths of sub-services and their associated environmental impact for the provision of services. Recording the environmental impact of the sub-services enabling the delivery of services allows the calculation of the overall environmental impact associated with the delivery of services. Further, at step 25, the determination and recordal of network paths of sub-services occurs for each service level offered thus enabling a calculation of the environmental impact for all of the services offered by an organization for each service level associated with each service offering.

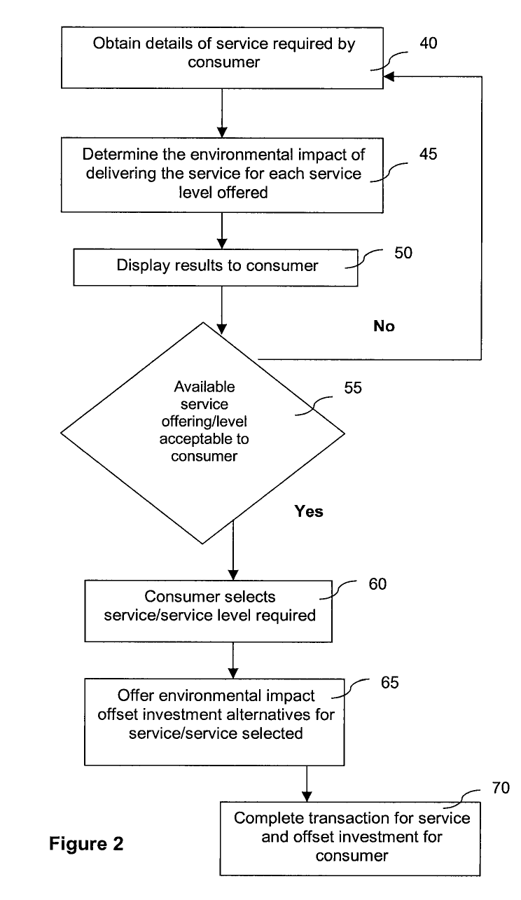

With reference to FIG. 2, the primary method steps effected by a prospective consumer are detailed. In particular, at step 40, the details of a service required by a prospective consumer are obtained and the environmental impact of delivering the service for each service level offering is determined (step 45), as per the techniques described above relative to FIG. 1.

At step 50, the calculations of the environmental impact of the service alternatives are displayed to the prospective consumer. In the event that there is an available service offering at a level that is acceptable to the consumer then the method proceeds to step 60. However, if none of the service offering/levels displayed to the consumer are acceptable (as a result of either the service offered or the environmental impact thereof) the method reverts to step 40 where the prospective consumer may alter the details of the service they require. Steps 40, 45, 50 and 55 may be repeated as many times as necessary by the prospective consumer until they locate an available service offering/level that accommodates their requirements with respect to both the service provided and the environmental impact thereof.

Once a service offering/level has been located by the prospective consumer that is satisfactory, the method proceeds to step 60 wherein the consumer selects the service at the level that accommodates their requirements with an environmental impact that is acceptable to the consumer. At step 65, the method includes the provision of an offer to the consumer to offset the environmental impact of the service they selected at step 60. The prospective consumer may elect one of a range of environmental impact offset alternatives and then proceed to step 70 wherein the transaction for the service and the offset option is completed.

Those skilled in the relevant field of technology will appreciate that the invention described herein is susceptible to variations and modifications other than those specifically described. It is understood that the invention includes all such variations and modifications that fall within the spirit and scope of the present invention.

We claim:

1. In one aspect, the present invention provides a method of informing prospective consumers of the environmental impact of the services offered by an organization, the method including:
receiving information from a prospective consumer with respect to the service required;
determining the environmental impact of each element in the delivery of all sub-services that enable delivery of the type of service required; and
presenting information to the prospective consumer including an estimate of the environmental impact of the delivery of the service required and, where available, alternative service delivery options and the respective environmental impact of those alternatives/options.

2. An environmental impact calculator that calculates the environmental impact of the delivery of services by an organization, the calculator receiving information from a prospective consumer with respect to a required service, establishing the available services offered by the organization that accommodate the consumers' requirements, calculating the environmental impact of the relevant services by summing the environmental impact of each element in the delivery of sub-services that contribute to the delivery of the relevant services and providing the calculated environmental impact for each service.
